(19) United States
(12) Patent Application Publication
(10) Pub. No.: US 2010/0227756 A1
(43) Pub. Date: Sep. 9, 2010

(54) METHOD FOR MANUFACTURING CATALYST FOR FUEL CELL

(75) Inventors: Hansung Kim, Seoul (KR); Katie Heeyum Lim, Seoul (KR); Hyung-Suk Oh, Incheon (KR); In Chul Hwang, Gyeonggi-do (KR); Bumwook Roh, Gyeongg-Do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); Industry-Academic Cooperation Foundation, Younsei University, Seodaemun-gu (KR)

(21) Appl. No.: 12/510,301

(22) Filed: Jul. 28, 2009

(30) Foreign Application Priority Data
Mar. 5, 2009 (KR) 10-2009-0018829

(51) Int. Cl. H01M 4/88

(52) U.S. Cl. 502/101

(57) ABSTRACT

The present invention provides a method for manufacturing a catalyst for a fuel cell. The method of the present invention can manufacture a cathode catalyst for a fuel cell having excellent corrosion resistance using carbon nanocages (CNC).

### CROSS-REFERENCE TO RELATED APPLICATION

This application claims under 35 U.S.C. §119(a) the benefit of Korean Patent Application No. 10-2009-0018829 filed Mar. 5, 2009, the entire contents of which are incorporated herein by reference.

### BACKGROUND

(a) Technical Field

The present disclosure relates to a method for manufacturing a catalyst for a fuel cell having excellent corrosion resistance. More particularly, it relates to a method for manufacturing a cathode (air electrode) catalyst for a fuel cell having excellent corrosion resistance using carbon nanocages (CNC).

(b) Background Art

Presently, research directed towards preparing platinum nanoparticles and supporting platinum on carbon having high specific surface area with high dispersion in order to increase the catalytic activity of a fuel cell has continued to progress (J. Power Sources, 130, 73).

Carbon black is generally used as a platinum support. However, when carbon black is used as a platinum support, the durability of the catalyst can deteriorate due to carbon corrosion during operation of the fuel cell (J. Power Sources, 183, 619).

To address this problem, three methods have been proposed.

In a first approach, research related to a fuel cell catalyst, in which crystalline carbon materials, such as carbon nanotubes (CNT), carbon nanofibers (CNF), etc. are used as a support, has been carried out (J. Power Sources, 158, 154). In another approach, research on the use of a conductive polymer as a fuel cell catalyst support has continued to progress (Electrochimica Acta 50, 769). Lastly, research on the use of a conductive metal oxide as a support has also continued to progress (Inter. J. Hydrogen Energy, xxx, I-6).

Among these approaches, the research on the use of new carbon materials such as CNT, CNF, etc., as the fuel cell support has been most active. Initially, the research on the use of the CNT or CNF as the fuel cell support was concentrated on the improvement of the fuel cell performance (Catalyst Today, 102-103, 58).

Corrosion research on the CNT and CNF has been pursued using a half cell test in which an aqueous solution is used as an electrolyte (Electrochimica Acta, 51, 5853). Previously, the corrosion rate was evaluated from current peaks occurring at 0.5 V, at time points of 0 hour, 16 hours, and 120 hours, when a cyclic voltammetry (CV) test was performed at a rate of 10 mVs⁻¹ while applying a constant potential of 1.2 V to CNT and carbon black for 120 hours.

The material generated in the current peak area corresponds to an oxide peak by hydroquinone/quinone couples on the support surface during electrochemical oxidation and is the material before carbon dioxide (CO₂) as a corrosion product is generated.

Accordingly, it has been determined that the corrosion reaction rate is higher when the amount of oxide is larger, and it has thus been determined that carbon black is easily oxidized compared to CNT. However, since the support oxide is not converted 100% into carbon dioxide (CO₂) as a corrosion product, there is a limitation in evaluating the corrosion rate from the surface oxide.

Accordingly, research on the use of mass spectrometry for directly measuring the amount of carbon dioxide (CO₂) as a corrosion product has been conducted (J. Power Sources, 176, 444). However, the research has been aimed only at studying corrosion tendency of the cathode catalyst of the fuel cell and has not been used for quantitative evaluation of corrosion. Moreover, in the preparation of fuel cell catalyst materials using the crystalline carbon materials such as CNT, CNF, etc., as a support, it is difficult to prepare a catalyst at a high rate due to low specific surface area (BET) compared to the carbon black.

The above information disclosed in this Background section is only for the enhancement of understanding of the background of the invention and therefore it may contain information that does not form the prior art that is already known in this country to a person of ordinary skill in the art.

### SUMMARY OF THE DISCLOSURE

In one aspect, the present invention provides a method for manufacturing a cathode catalyst for a fuel cell using carbon nanocages (CNC) as a platinum support. The present invention is based, in part, on the finding that through a quantitative evaluation using mass spectrometry, carbon nanocages (CNC) used as a platinum support have excellent corrosion resistance compared to the case where carbon black is used.

In certain preferred aspects, the present invention provides a method for manufacturing a catalyst for a fuel cell having excellent corrosion resistance, the method comprising: a first step of preparing carbon nanocages (CNC) using acetylene black as carbon black; a second step of mixing predetermined amounts of NaOH, platinum precursor, and carbon with ethylene glycol, which is a solvent but also serves as a reducing agent, and stirring the solution; a third step of reducing the platinum precursor by oxidizing the ethylene glycol; a fourth step of increasing loading level of platinum by pH control; and a fifth step of removing unnecessary organic substances by washing and heat treatment.

In another preferred embodiment, the first step may preferably include the step of mixing the acetylene black with a predetermined amount of ferric nitrate [Fe(NO₃)₃9H₂O], the step of heat-treating the resulting solution under a nitrogen atmosphere at 2,400 to 2,800° C. for a predetermined period of time, and the step of immersing the carbon nanocages obtained after heat-treatment in nitric acid to remove impurities.

In another preferred embodiment, the second step may include the step of mixing a predetermined amount of NaOH with the ethylene glycol to suitably maintain pH above 12 and the step of mixing predetermined amounts of platinum precursor and carbon nanocages with the resulting solution and stirring the solution.

In still another preferred embodiment, the platinum precursor may be one selected from the group consisting of, but not limited to, platinum chloride, potassium tetrachloroplatinate, and tetraammineplatinum chloride.

In yet another preferred embodiment, the third step may include the step of refluxing the resulting solution after the first and second steps at 140 to 180° for 3 hours and the step of stirring the resulting solution for 12 hours after lowering the temperature to room temperature after reaction and exposing the solution to air.

In still yet another preferred embodiment, glycolate anion generated by the oxidation of the ethylene glycol may suitably serve as a protector that prevents the reduced platinum particles from being sintered to each other.

In a further preferred embodiment, the fourth step may suitably increase the loading level of platinum by lowering the pH using one selected from the group consisting of hydrochloric acid, sulfuric acid, and nitric acid such that the surface potential of the platinum may have a predetermined negative potential value and the surface potential of the carbon may be suitably increased to a positive value.

In another further preferred embodiment, the fifth step may include the step of completely washing organic acids and impurities generated during the oxidation of the ethylene glycol with ultrapure water and the step of drying the resulting catalyst in a convection oven at 160° C.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing measurement of carbon dioxide (CO₂) as a corrosion product of a cathode (air electrode) catalyst for a fuel cell using mass spectrometry;

FIG. 2 is a flowchart illustrating procedures and conditions of corrosion test of a cathode catalyst for a polymer fuel cell;

FIG. 3 shows high-resolution transmission electron microscopy (HR-TEM) images of carbon black particles and carbon nanocages (CNC) used as supports for the preparation and evaluation of a catalyst having high corrosion resistance of the present invention;

FIG. 4 shows HR-TEM images taken at a higher magnification of carbon black particles and carbon nanocages (CNC) used as supports for the preparation and evaluation of a catalyst having high corrosion resistance of the present invention;
FIG. 5 shows XRD patterns of carbon black particles and carbon nanocages (CNC) used as supports for the corrosion resistance test of the present invention;

FIG. 6 shows HR-TEM images of Pt/C (carbon black and CNC) catalysts used for the corrosion resistance test of the present invention;

FIG. 7 is a table showing properties (loading levels, particle sizes, and effective surface areas) of platinum of Pt/C (carbon black and CNC) catalysts used for the corrosion resistance test of the present invention;

FIG. 8 shows graphs showing results of MEA performance evaluation before and after corrosion of Pt/C (carbon black and CNC) catalysts used for the corrosion resistance test of the present invention;

FIG. 9 shows graphs showing changes in impedance before and after corrosion of Pt/C (carbon black and CNC) catalysts used for the corrosion resistance test of the present invention;

FIG. 10 shows graphs showing results of a cyclic voltammetry (CV) test before and after corrosion of Pt/C (carbon black and CNC) catalysts used for the corrosion resistance test of the present invention;

FIG. 11 is a graph showing the amounts of carbon dioxide (CO₂) measured using mass spectrometry during the corrosion resistance test of Pt/C (carbon black and CNC) catalysts used for the corrosion resistance test of the present invention;

FIG. 12 is a table showing the test results of FIGS. 8 to 11;

FIG. 13a is a picture showing a state of dispersion of carbon black in water, and FIG. 13b is a picture showing a state of dispersion after CNC is added to a container containing hexane and water; and

FIG. 14 is a graph showing the CV test result with reference to CNF and CNC.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features a method for manufacturing a catalyst for a fuel cell having excellent corrosion resistance, the method comprising a first step of preparing carbon nanocages (CNC), a second step of mixing predetermined amounts of NaOH, platinum precursor, and carbon with ethylene glycol, which is a solvent but also serves as a reducing agent, and stirring the solution, a third step of reducing the platinum precursor, a fourth step of increasing loading level of platinum, a fifth step of removing unnecessary organic substances.

In one embodiment, the first step of preparing carbon nanocages (CNC) further comprises using acetylene black as carbon black.

In another embodiment, the third step of reducing the platinum comprises oxidizing the ethylene glycol.

In still another embodiment, the fourth step of increasing loading level of platinum is carried out by pH control.

In another further embodiment the fifth step of removing unnecessary organic substances is carried out by washing and heat treatment.

In another embodiment, the first step further comprises the step of mixing the acetylene black with a predetermined amount of ferric nitrate [Fe(NO3)39H2O].

In one embodiment, the first step further comprises the step of heat-treating the resulting solution under a nitrogen atmosphere at 2,400 to 2,800° C. for a predetermined period of time.

In another embodiment, the first step further comprises the step of immersing the carbon nanocages obtained after heat-treatment in nitric acid to remove impurities.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

As described herein, the present invention provides a cathode catalyst for a fuel cell having excellent corrosion resistance which has been confirmed through a corrosion test method employing mass spectrometry, and thus it is possible to provide a platinum-supported catalyst using carbon nanocages (CNC) as a support, which remedies the defects of CNT and CNF which have high corrosion resistance but are not suitable for a fuel cell catalyst due to low specific surface area (BET).

In preferred embodiments, the carbon nanocage (CNC) is crystalline carbon obtained by heat-treating carbon black at 2,800° C. and is preferably a catalyst support having advantages of CNT and carbon black. It was confirmed that a nanoparticle platinum-supported catalyst (Pt/CNC) could be suitably synthesized using the CNC via a polyol process and the synthesized Pt/CNC is a catalyst having high corrosion resistance through the corrosion test method developed by the present invention.

A method for manufacturing a Pt/CNC catalyst of the present invention using carbon nanocages (CNC) having high corrosion resistance as a support via a polyol process will be described below.

(A) Step of Preparing Carbon Nanocages (CNC)

In a preferred embodiment of the invention as described herein, a starting material used in preparing carbon nanocages (CNC) is acetylene black as carbon black.

Preferably, the acetylene black is mixed with a predetermined amount of ferric nitrate [Fe(NO₃)₃9H₂O] and heat-treated under a nitrogen atmosphere at 2,400 to 2,800° C. for a predetermined period of time. In a further embodiment, the thus obtained carbon nanocages (CNC) are suitably immersed in nitric acid to remove impurities.

(B) Step of Mixing NaOH, Platinum Precursor, and Carbon with a Solvent

In a further embodiment, ethylene glycol used in Step (B) is a solvent but also suitably serves as a reducing agent. Preferably, glycolate anion generated during the oxidation of the ethylene glycol serves as a suitable stabilizer so that the platinum particles are of nanosize. Preferably, a predetermined amount of NaOH is suitably mixed with the ethylene glycol to maintain pH above 12, and a predetermined amount of platinum precursor is suitably mixed with the resulting solution and then stirred. As the platinum precursor, platinum chloride, potassium tetrachloroplatinate, or tetraammineplatinum chloride may be used, however other platinum precursors may be contemplated. Subsequently, carbon nanocages (CNC) are mixed with the resulting solution and sufficiently stirred.

(C) Step of Reducing the Platinum Precursor by Oxidation of Ethylene Glycol

In Step (C), the platinum precursor is suitably reduced. First, the solution of step (B) is refluxed at 140 to 180° C. for 3 hours. Thus, the platinum precursor is suitably reduced while the ethylene glycol is oxidized. In further embodiments, the glycolate anion generated during the oxidation of the ethylene glycol serves as a protector that suitably prevents the reduced platinum particles from being sintered to each other. In another further embodiment, after the reaction, the temperature is lowered to room temperature, and the reaction solution is suitably exposed to air and stirred for 12 hours.

(D) Step of Increasing Loading Level of Platinum by pH Control

In Step (D), the loading level of platinum is suitably increased by lowering pH.

Preferably, an acid such as hydrochloric acid, sulfuric acid, or nitric acid is used to lower the pH. When the pH is lowered, the surface potential of the platinum has a predetermined negative potential value, and on the contrary, the surface potential of the carbon is suitably increased to a positive value. Accordingly, since the surface potentials of the platinum and carbon are controlled by lowering the PH, it is possible to suitably improve the surface tension between platinum and carbon. As a result, the platinum particles are easily supported on the carbon particles, and thus it is possible to suitably increase the loading amount of platinum particles without sintering of the platinum particles.

(E) Step of Removing Unnecessary Organic Substances by Washing and Heat Treatment

In Step (E), the resulting catalyst is collected and unnecessary organic substances are suitably removed from the catalyst by washing and heat treatment.

Organic acids and impurities generated during the oxidation of the ethylene glycol are completely washed with ultrapure water and the resulting catalyst is suitably dried in a convection oven at 160° C.

According to further embodiments, the Pt/CNC catalyst prepared using the thus prepared carbon nanocages (CNC) as a support can be easily used as a cathode catalyst for a polymer fuel cell having high corrosion resistance.

According to further preferred embodiments, a corrosion test method for a cathode catalyst for a fuel cell according to the present invention will be described with reference to the accompanying drawings.

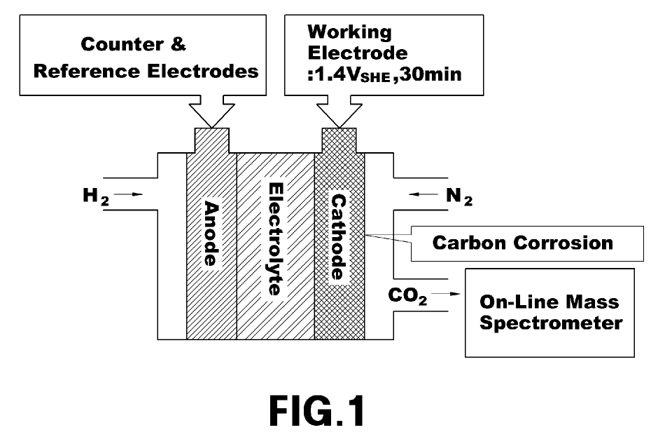

FIG. 1 is a schematic diagram showing exemplary measurement of carbon dioxide (CO₂) as a corrosion product of a cathode catalyst for a fuel cell using mass spectrometry.

Preferably, counter and reference electrodes of a potentiostat are suitably connected to a fuel electrode (“hydrogen electrode” or “anode”) of a fuel cell shown in FIG. 1, and a working electrode is connected to an air electrode (“oxygen electrode” or “cathode”). A mass spectrometer performing mass spectrometry is suitably connected to an outlet of the cathode.

A constant voltage of 1.4 V_{SHE}, which can cause electrochemical corrosion, is suitably applied to the cathode for 30 minutes using the potentiostat such that the platinum-supported catalyst of the cathode is oxidized.

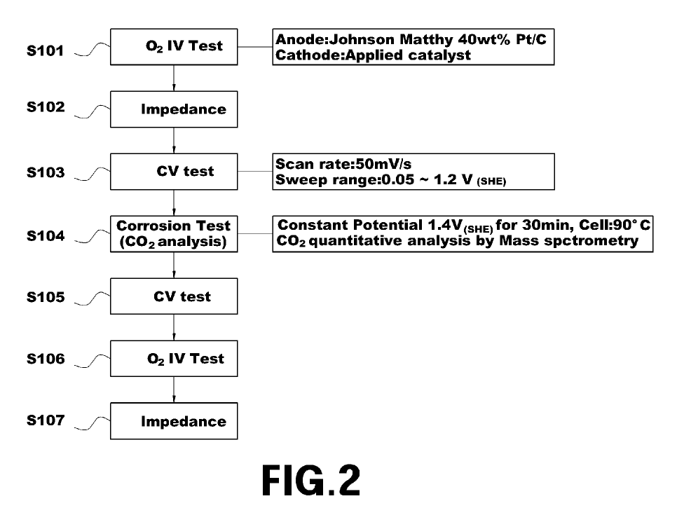

FIG. 2 is a flowchart illustrating exemplary procedures and conditions of corrosion test of a cathode catalyst for a polymer fuel cell.

In certain preferred embodiments of the invention, as the corrosion test conditions, 20 ccm hydrogen is preferably supplied to the fuel electrode (anode), and 30 ccm nitrogen is supplied to the air electrode (cathode). Preferably, at this time, the temperature of the unit cell is suitably maintained at 90° C., and the humidification temperature is maintained at 90° C.

According to further preferred embodiments of the invention, first, the performance evaluation of the oxygen condition of the cathode is performed (S101).

Then, in further embodiments, in order to measure an effective surface area of platinum supported on the cathode catalyst, a cyclic voltammetry (CV) curve is measured by a CV test (S103) at a scan rate of 50 mV/s and a potential range of 0.05 to 1.2 V_{SHE}.

Subsequently, in other further embodiments, the amount of carbon dioxide (CO₂) discharged through an outlet of the cathode is measured in real time using a mass spectrometer during corrosion test (S104).

Preferably, at this time, impedances are suitably measured (S102 and S107) to compare changes in performance of a membrane electrode assembly (MEA) and changes in membrane resistance and charge transfer resistance so as to evaluate the corrosion resistance of the cathode catalyst before and after corrosion. Further, the amount of CO₂ of the cathode before the measurement of impedance (S107) is measured to perform a corrosion test (S104), and the CV test (S105) and the performance evaluation of the oxygen condition of the cathode are suitably performed (S106).

According to further preferred embodiments of the invention, it is possible to measure the corrosion rate of the cathode catalyst through the above steps, and it is determined that the catalyst has higher corrosion resistance when the performance degradation rate of the unit cell before and after corrosion is suitably smaller, when the reduction rate of the effective active surface area (Spt) of platinum measured by the CV test is suitably smaller, when the resistance increase rate measured by the impedance is suitably smaller, and when the amount of carbon dioxide (CO₂) measured by the mass spectrometry is suitably smaller.

The above-described corrosion test of the cathode catalyst for a fuel cell through the mass spectrometry according to the present invention will be described in more detail below.

(A) Step of Preparing an MEA

Preferably, commercially available catalyst is suitably coated with a predetermined amount of Nafion solution on a polymer electrolyte membrane for a fuel electrode (“hydrogen electrode” or “anode”).

Then, a catalyst to be evaluated is suitably coated with a predetermined amount of Nafion solution on a polymer electrolyte membrane for an air electrode (“oxygen electrode” or “cathode”).

In further embodiments, a gas diffusion layer (GDL) and a gasket are suitably stacked on the thus prepared membrane electrode assembly (MEA) to form a unit cell. Preferably, a predetermined pressure is applied to the unit cell so as to suitably connect the respective components, and the resulting unit cell is connected to a predetermined station.

(B) Step of Evaluating the Oxygen Condition of the Cathode (S101)

In this step, the performance of the unit cell is evaluated. Preferably, a predetermined amount of hydrogen is suitably supplied to the anode, and a predetermined amount of oxygen is suitably supplied to the cathode. Preferably, the temperature of the unit cell and the temperature of a humidifier connected to the unit cell are preferably maintained at 75 to 90° C.

For example, in certain preferred embodiments, 20 ccm hydrogen is suitably supplied to the anode, and 30 ccm nitrogen is suitably supplied to the cathode. At this time, the temperature of the unit cell is maintained at 90° C., and the humidification temperature is maintained at 90° C.

Preferably, in certain embodiments of the invention as described, the above conditions are maintained at 0.6 V for a predetermined period of time so as to suitably stabilize the unit cell, and an IV curve is obtained for the performance evaluation of the unit cell after the stabilization.

(C) Step of Measuring Impedance (S102)

In this step, an impedance of the unit cell is measured at a constant potential of 0.8 V, an amplitude of 10 mV, and a frequency of 4,000 to 0.1 Hz.

In preferred embodiments, the membrane resistance and the charge transfer resistance are suitably measured through the impedance obtained while a predetermined amount of hydrogen is suitably supplied to the anode and a predetermined amount of oxygen is suitably supplied to the cathode, for example, when 20 ccm hydrogen is suitably supplied to the anode and 30 ccm nitrogen is suitably supplied to the cathode.

(D) Step of Measuring a Cyclic Voltammetry (CV) Curve Under a Nitrogen Atmosphere at the Cathode (S103)

According to preferred embodiments, in this step, a CV curve is measured so as to measure the active surface area of the platinum catalyst. Preferably, the CV test is performed at a scan rate of 50 mV/s and a potential range of 0.05 to 1.2 V_{SHE} while a predetermined amount of hydrogen is suitably supplied to the anode and a predetermined amount of oxygen is supplied to the cathode, for example, when 20 ccm hydrogen is suitably supplied to the anode and 30 ccm nitrogen is suitably supplied to the cathode.

(E) Step of Evaluating the Corrosion of the Cathode Catalyst and Measuring the Amount of CO₂ (S104)

In further embodiments of the present invention, constant voltage of 1.4 V_{SHE} is applied to the cathode for 30 minutes such that the cathode catalyst is suitably corroded.

Then, in further embodiments, the amount of carbon dioxide (CO₂) generated during the corrosion test is suitably measured using a mass spectrometry connected to an outlet of the cathode of the unit cell.

(F) Step of Repeatedly Measuring the CV Curve Under a Nitrogen Atmosphere at the Cathode (S105)

According to preferred embodiments, in this step, the CV curve is repeatedly measured so as to measure the active surface area of the platinum catalyst after the corrosion test of the cathode catalyst, i.e., after the cathode catalyst is suitably corroded. Preferably, the CV test is performed at a scan rate of 50 mV/s and a potential range of 0.05 to 1.2 V_{SHE} while a predetermined amount of hydrogen is suitably supplied to the anode and a predetermined amount of oxygen is supplied to the cathode, for example, when 20 ccm hydrogen is suitably supplied to the anode and 30 ccm nitrogen is supplied to the cathode.

(G) Step of Repeatedly Performing the Performance Evaluation of the Oxygen Condition of the Cathode (S106)

According to other preferred embodiments n this step, the performance of the unit cell is repeatedly evaluated after the corrosion test of the cathode catalyst, i.e., after the cathode catalyst is suitably corroded. For example, preferably in the same manner as in Step (A), a predetermined amount of hydrogen is suitably supplied to the anode and a predetermined amount of oxygen is suitably supplied to the cathode. Preferably, at this time, the temperature of the unit cell and the temperature of a humidifier connected to the unit cell are suitably maintained at 75 to 90° C.

For example, 20 ccm hydrogen is suitably supplied to the anode, and 30 ccm nitrogen is supplied to the cathode. At this time, the temperature of the unit cell is suitably maintained at 90° C., and the humidification temperature is suitably maintained at 90° C.

In further preferred embodiments, the above conditions are maintained at 0.6 V for a predetermined period of time so as to stabilize the unit cell, and an IV curve is obtained for the performance evaluation of the unit cell after the stabilization.

(H) Step of Repeatedly Measuring the Impedance (S107)

According to preferred embodiments, in this step, the impedance is repeatedly measured to compare changes in performance of the MEA and changes in membrane resistance and charge transfer resistance so as to suitably evaluate the corrosion resistance of the cathode catalyst before and after corrosion. Preferably, this step is performed in the same manner as in Step (C).

Next, examples of the present invention will be described in more detail. However, the present invention is not limited to the following examples.

### COMPARATIVE EXAMPLE

### Corrosion Test of 38 wt % Pt/Ketjen Black EC300J Catalyst using Carbon Black as a Support

In this exemplary embodiment, 0.075 M NaOH was mixed with ethylene glycol as a solvent and stirred for 20 minutes to be dissolved, and then a predetermined amount of platinum precursor (PtCl₄) was added to the solution and stirred for 20 minutes to be dissolved.

A predetermined amount of conductive carbon black (Ketjen Black EC300J) was added to the resulting solution to obtain a 40 wt % Pt/C catalyst and stirred for 20 minutes. The resulting solution was refluxed at 160° C. for 3 hours.

In other embodiments of the invention as described, after the reaction, the temperature was lowered to room temperature, and the pH was lowered to 3 using H₂SO₄. Then, the resulting solution was exposed to air and stirred for 12 hours. Preferably, the resulting solution was filtered using a decompressor to collect powder, and the collected powder was washed with ultrapure water several times. Preferably, subsequently, the washed powder was dried in an oven at 160° C. for about 30 minutes.

Preferably, a commercially available 40 wt % Pt/C (Johnson Matthey) catalyst mixed with a 5 wt % Nafion solution was coated on the surface of the anode of a Nafion membrane (N212 Nafion Membrane) at a Pt loading of 0.4 mg/cm⁻².

According to further embodiments, in the same manner, a 40 wt % Pt/C (Ketjen Black EC300J) catalyst mixed with a 5 wt % Nafion solution was coated on the surface of the cathode of a Nafion membrane (N212 Nafion Membrane) at a Pt loading of 0.4 mg/cm⁻².

In further exemplary embodiments, subsequently, a gas diffusion layer (GDL) and a gasket were connected to both sides of the thus prepared MEA, i.e., the fuel electrode and cathode catalysts, to form a unit cell, and the corrosion test was performed on the thus formed unit cell. In further embodiments of the present invention, as the corrosion test method for the cathode catalyst according to the present invention, (B) Step of evaluating the oxygen condition of the cathode (S101), (C) Step of measuring the impedance (S102), (D) Step of measuring a CV curve under a nitrogen atmosphere at the cathode (S103), (E) Step of evaluating the corrosion of the cathode catalyst and measuring the amount of CO₂ (S104), (F) Step of repeatedly measuring the CV curve under a nitrogen atmosphere at the cathode (S105), (G) Step of repeatedly performing the performance evaluation of the oxygen condition of the cathode (S106), and (H) Step of repeatedly measuring the impedance (S107) were preferably performed.

Preferably, upon completion of the above steps, the measured values before and after corrosion, such as the performance degradation rate of the unit cell, the reduction rate of the effective active surface area (Spt) of platinum suitably measured by the CV test, the resistance increase rate suitably measured by the impedance, and the amount of carbon dioxide (CO₂) suitably measured by the mass spectrometry, were compared to evaluate the corrosion resistance of the catalyst.

### EXAMPLE

### Corrosion Test of 38 wt % Pt/CNC Catalyst Using Carbon Nanocages (CNC) as a Support

Acetylene black and ferric nitrate [Fe(NO₃)₃9H₂O] were mixed in a mass ratio of 1:12 with ethanol and subjected to ultrasonic treatment for 15 minutes using an ultrasonic rod so as to be suitably dispersed.

Preferably, the resulting solution was washed with ultrapure water several times, and then carbon is obtained using a vacuum filter.

Preferably, the thus obtained carbon was placed in a furnace and heat-treated under a nitrogen atmosphere at 2,800° C. for 10 hours to obtain carbon nanocages (CNC). Preferably, the thus obtained CNC was immersed in nitric acid for 2 days to remove impurities.

In a preferred embodiment, the resulting CNC was subjected to the above-described polyol process to suitably prepare a platinum-supported catalyst.

In detail, in certain exemplary embodiments, 0.075 M NaOH was mixed with ethylene glycol as a suitable solvent and stirred for 20 minutes to be dissolved, and then a predetermined amount of platinum precursor (PtCl₄) was added to the solution and stirred for 20 minutes to be dissolved. In further embodiments, a predetermined amount of CNC was added to the resulting solution to obtain a 40 wt % Pt/C catalyst and stirred for 20 minutes. Preferably, the resulting solution was refluxed at 160° C. for 3 hours.

According to further exemplary embodiments of the invention, after the reaction, the temperature was lowered to room temperature, and the pH was suitably lowered to 3 using H₂SO₄. Then, the resulting solution was exposed to air and stirred for 12 hours. The resulting solution was suitably filtered using a decompressor to collect powder, and the collected powder was washed with ultrapure water several times. Preferably, the washed powder was dried in an oven at 160° C. for about 30 minutes.

In further embodiments of the invention, a commercially available 40 wt % Pt/C (Johnson Matthey) catalyst mixed with a 5 wt % Nafion solution was coated on the surface of the anode of a Nafion membrane (N212 Nafion Membrane) at a Pt loading of 0.4 mg/cm⁻².

In the same manner, the thus prepared 40 wt % Pt/CNC catalyst mixed with a 5 wt % Nafion solution was suitably coated on the surface of the cathode of a Nafion membrane (N212 Nafion Membrane) at a Pt loading of 0.4 mg/cm⁻².

Subsequently, in the same manner as the Comparative Example, a gas diffusion layer (GDL) and a gasket were suitably connected to both sides of the thus prepared MEA, i.e., the fuel electrode and cathode catalysts, to form a unit cell, and the corrosion test was performed on the thus formed unit cell. According to preferred embodiments of the invention, as the corrosion test method for the cathode catalyst according to the present invention, (B) Step of evaluating the oxygen condition of the cathode (S101), (C) Step of measuring the impedance (S102), (D) Step of measuring a CV curve under a nitrogen atmosphere at the cathode (S103), (E) Step of evaluating the corrosion of the cathode catalyst and measuring the amount of CO₂ (S104), (F) Step of repeatedly measuring the CV curve under a nitrogen atmosphere at the cathode (S105), (G) Step of repeatedly performing the performance evaluation of the oxygen condition of the cathode (S106), and (H) Step of repeatedly measuring the impedance (S107) were performed.

Preferably, upon completion of the above steps, the measured values before and after corrosion, such as the performance degradation rate of the unit cell, the reduction rate of the effective active surface area (Spt) of platinum measured by the CV test, the resistance increase rate measured by the impedance, and the amount of carbon dioxide (CO₂) suitably measured by the mass spectrometry, were compared to evaluate the corrosion resistance of the catalyst.

Next, as Test Examples according to the Example and Comparative Example, the test results of the corrosion resistance of the catalysts will be described in comparison with each other with reference to the accompanying drawings.

### Test Example 1

### Comparison of Carbon Black Particles and CNC Particles

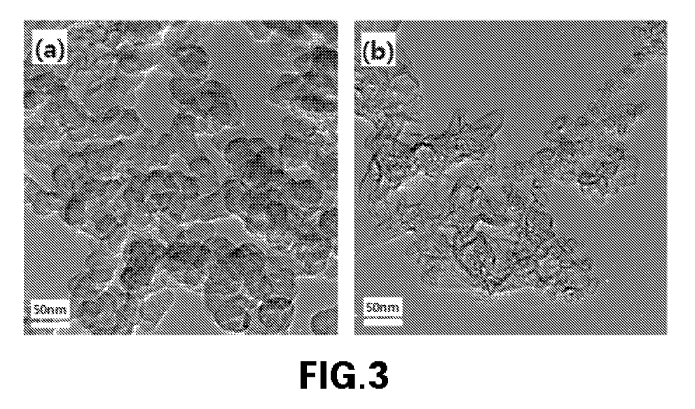

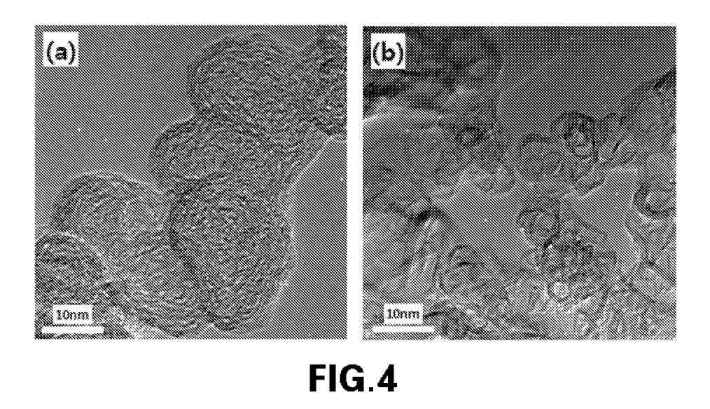

FIGS. 3 and 4 show HR-TEM images taken at 50,000 and 200,000 magnifications of carbon black particles and carbon nanocages (CNC) used as catalyst supports.

FIGS. 3a and 4a show non-crystalline carbon black used in the Example to compare the corrosion resistance of crystalline carbon, and FIGS. 3b and 4b show carbon nanocages (CNC) prepared by crystallizing the non-crystalline carbon black, i.e., acetylene black, used in the Example at 2,800° C.

As shown in FIGS. 3a and 4a that 20 to 50 nm or 30 nm elliptical carbon particles are suitably sintered or connected with each other.

On the contrary, it can be seen from FIGS. 3b and 4b that spherical carbon particles such as carbon black are connected with each other but their surfaces are not crystallized.

The results presented herein demonstrate that 10 to 20 nm spherical cages are connected to each other since the carbon nanocages (CNC) are prepared based on the carbon black particles, and the carbon grids of the spherical cages have a constant orientation and thus have a crystallinity.

### Test Example 2

### Comparison of Carbon Crystallinity Based on XRD Patterns

The crystallinity degree of carbon can be determined based on XRD patterns, and it is determined that the crystallinity degree is larger when the magnitude of a peak at 2Θ 25° is larger.

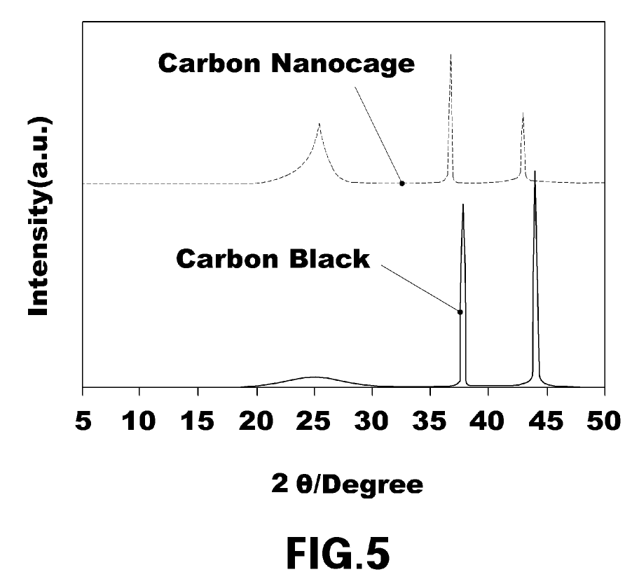

FIG. 5 shows XRD patterns at 2Θ 5 to 25° of carbon black particles (Ketjen Black EC300J) and carbon nanocages (CNC).

The results presented herein show that the peak magnitude at 2Θ 25° of the CNC was larger than that of the carbon black (Ketjen Black EC300J), and thus it could be concluded that the CNC had a crystallinity greater than the carbon black (Ketjen Black EC300J).

### Test Example 3

### Comparison of Platinum Particle Sizes

The sizes of platinum particles could be confirmed from high-resolution transmission electron microscopy (HR-TEM) images.

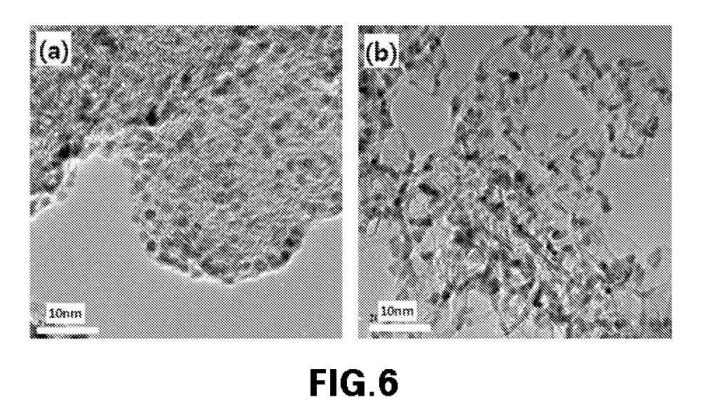

FIG. 6 shows HR-TEM images of platinum-supported catalysts prepared by the present invention, and the sizes of platinum particles could be confirmed from these images.

As shown in FIGS. 6a and 6b, the particle size of Pt/Carbon black was measured as 2.5 nm and that of Pt/CNC was also measured as 2.5 nm.

Thus, it can be concluded from the results presented herein that, even in the case where platinum was supported on the CNC as crystalline carbon, there was no increase in the platinum particle size compared to the case where platinum was supported on the carbon black.

### Test Example 4

### Comparison of Active Surface Areas of Platinum Catalyst and Platinum Particle Size

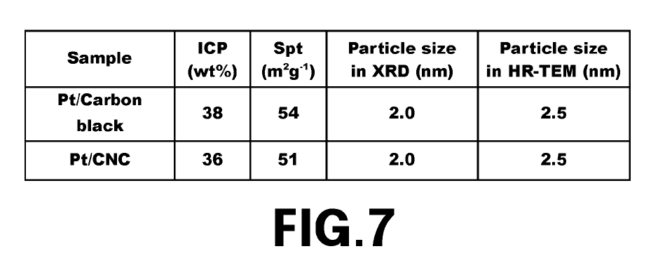

FIG. 7 is a table showing the ICP results as the loading levels of platinum on Pt/carbon black and Pt/CNC catalysts, the active surface areas of platinum catalysts measured by the CV test, and the platinum particle sizes measured by HR-TEM and XRD.

The loading level of platinum on each catalyst for a target of 40 wt % was 38 wt % in the case of Pt/carbon black and 36 wt % in the case of Pt/CNC.

In the case of Pt/CNC, it had a crystallinity and had substantially the same loading level as the Pt/carbon black.

Moreover, the active surface area of platinum of Pt/carbon black was measured as 54 m²g⁻¹ and that of Pt/CNC was measured as 51 m²g⁻¹, from which it could be concluded that there was no significant difference.

Further, the platinum particle size of Pt/carbon black measured by the HR-TEM was 2.5 nm and that of Pt/CNC was 2.5 nm, from which it could be concluded that the Pt/CNC catalyst had substantially the same loading level and platinum particle size as the Pt/carbon black catalyst.

### Test Example 5

### Test Results of the Corrosion Resistance of the Cathode Catalysts

(1) Results of Performance Comparison of the Unit Cell Before and After Corrosion

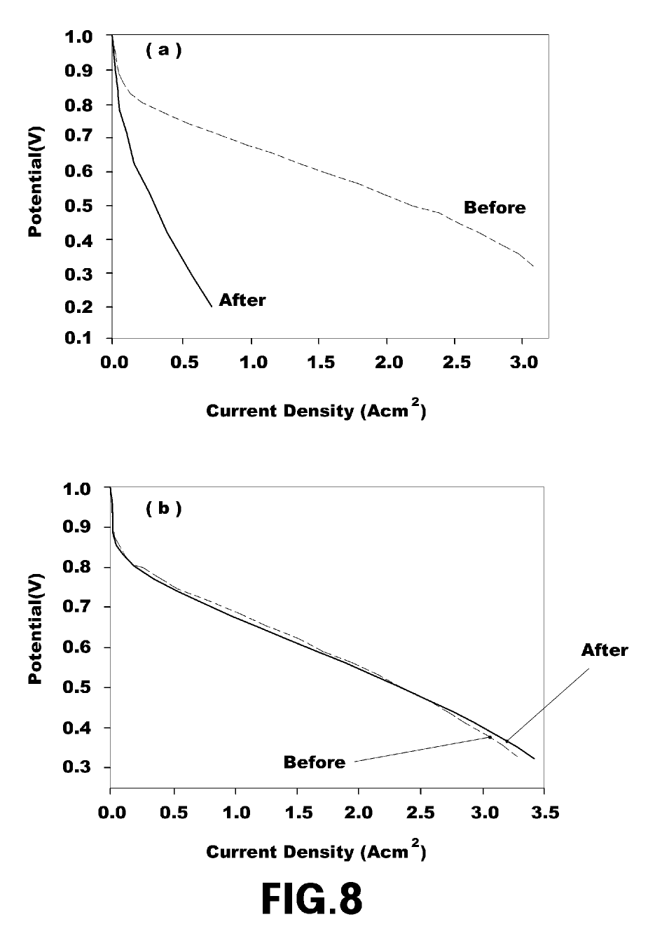

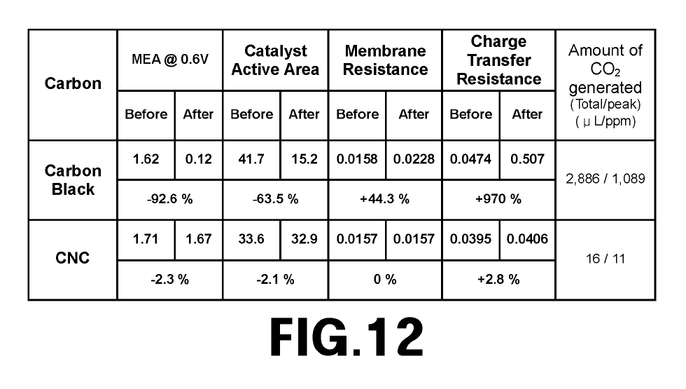

FIGS. 8 to 12 show test results of the corrosion resistance of two kinds of Pt/C catalysts, and the results are summarized in FIG. 12.

FIGS. 8a and 8b show the results of the unit cell performance before and after corrosion, in which the Pt/carbon black catalyst showed a performance of 1.62 Acm⁻² at 0.6 V before corrosion, and the Pt/CNC catalyst showed a performance of 1.71 Acm⁻², from which it could be understood that the performance of the CNC catalyst was higher than that of the carbon black catalyst.

In the same manner described above, a constant potential of 1.4 V_{SHE} was applied to the cathode to be corroded. As shown in FIG. 8a, the performance degradation rate of the Pt/carbon black catalyst according to the Comparative Example was 92.6% at 0.6 V. On the contrary, as shown in FIG. 8b, the performance degradation rate of the Pt/CNC catalyst according to the Examples of the present invention was 2.3% at 0.6 V.

Therefore, it was evaluated that the carbon black (Ketjen Black EC300J) according to the Comparative Example was vulnerable to corrosion and the CNC according to the Example of the present invention as described herein had higher corrosion resistance.

(2) Results of Comparison of the Membrane Resistance Before and After Corrosion

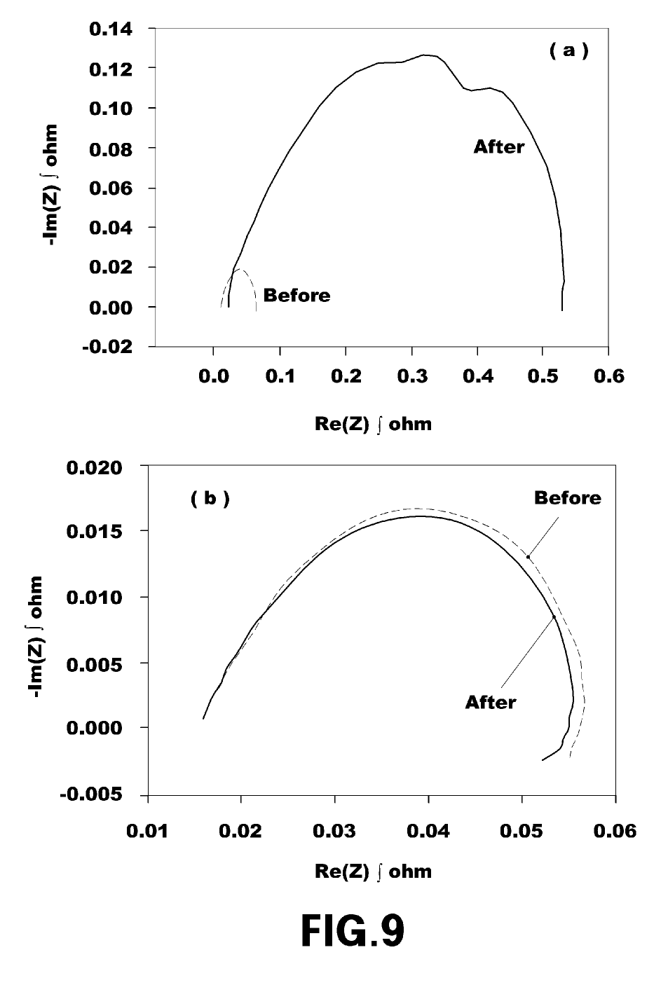

FIG. 9 shows graphs showing changes in membrane resistance and changes in charge transfer resistance by measuring the impedances before and after corrosion of the unit cell.

As shown in FIG. 9a, in the case of the catalyst using carbon black as a support according to the Comparative Example, the membrane resistance was increased 44.3% and the charge transfer resistance was increased 970%. On the contrary, as shown in FIG. 9b, in the case where the case of the catalyst using CNC as a support according to the Example of the present invention, the membrane resistance was not increased and the charge transfer resistance was increased 2.8%.

Since the membrane resistance and the charge transfer resistance of the carbon black were significantly increased, it could be concluded that the CNC is highly suitable for the support.

(3) Comparison of the Changes in Platinum Active Surface Area Before and After Corrosion

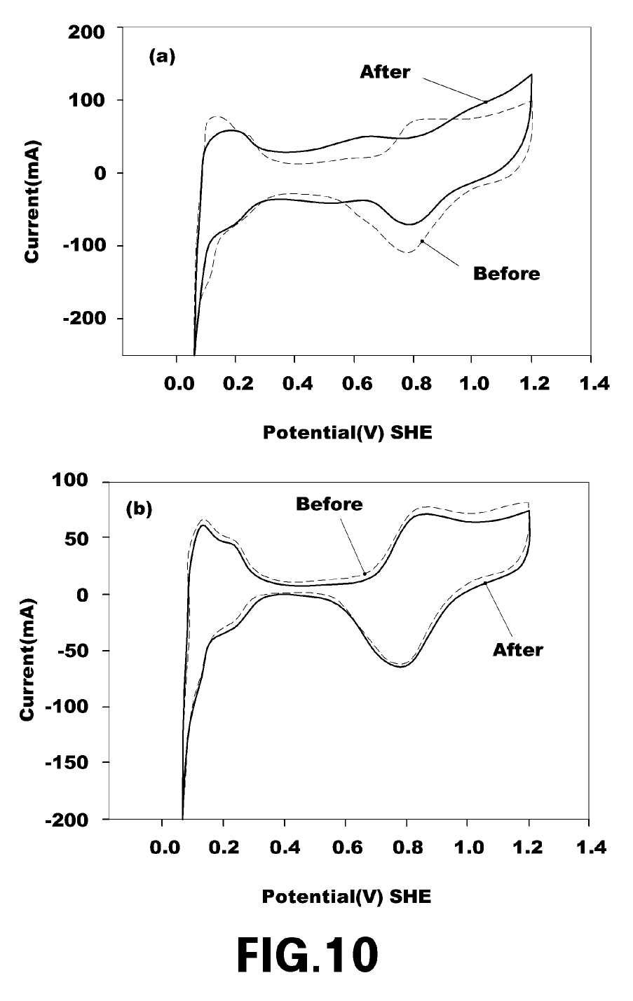

FIG. 10 shows CV graphs before and after corrosion of two kinds of Pt/C catalysts.

As shown in FIG. 10a, the change in platinum active surface area before and after corrosion of the Pt/carbon black according to the Comparative Example was reduced 63% from 41.7 m²g⁻¹ to 15.2 m²g⁻¹. On the contrary, as shown in FIG. 10b, the change in platinum active surface area before and after corrosion of the Pt/CNC according to the Example was reduced 2.1% from 33.6 m²g⁻¹ to 32.9 m²g⁻¹.

Therefore, it was confirmed again that the carbon black according to the Comparative Example was very vulnerable to corrosion and the CNC according to the Example of the present invention had higher corrosion resistance.

(4) Results of Measuring the Amount of Carbon Dioxide

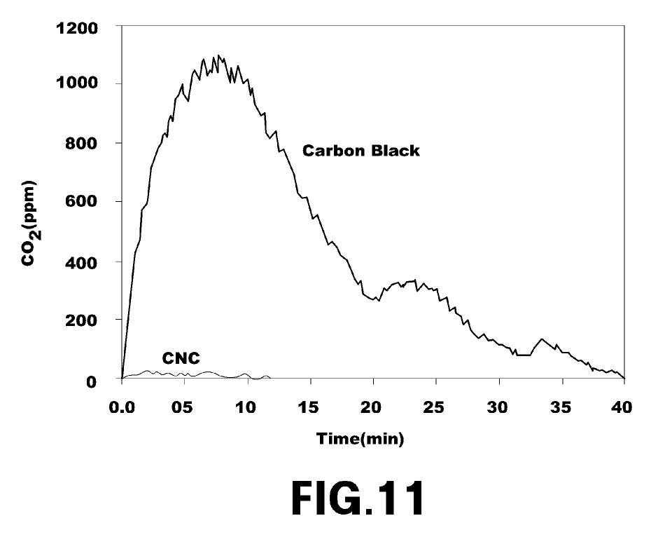

FIG. 11 shows the results of measuring the amounts of CO₂ as a corrosion product of two kinds of Pt/C catalysts using a cyclic voltammeter.

The corrosion of carbon as a fuel cell catalyst support proceeds in two steps. That is, an oxide is formed on the surface of the catalyst support, and then the surface oxide is converted into carbon dioxide (CO₂).

Since the surface oxide is not converted 100% into carbon dioxide (CO₂) during the oxidation, the measurement of the amount of carbon dioxide (CO₂) as a corrosion product is an accurate corrosion test method.

As can be seen in FIG. 11, in the case of the Pt/C catalyst using carbon black as a support according to the Comparative Example, the maximum amount of carbon dioxide generated was measured as 1,089 ppm; on the contrary, in the case of the Pt/CNC catalyst according to the Example of the present invention, the maximum amount of carbon dioxide generated was measured as 11 ppm, from which it could be concluded that the amount of carbon dioxide generated in the Pt/C catalyst using carbon black as a support was significantly greater than that of the Pt/CNC catalyst.

As such, it could be concluded that the crystalline carbon nanocages (CNC) have higher corrosion resistance than the carbon black.

### Test Example 6

### Corrosion Resistance Test Based on Hydrophobicity

The CNC according to the present invention has higher hydrophobicity than the carbon black and CNF, and this hydrophobicity could be confirmed from the XPS test results. The oxygen radicals on the surface of the CNC was 0.45% and that of the carbon black (Ketjen Black EC300J) was 4.02%, from which it could be ascertained that the CNC according to the present invention had less oxygen radicals than the other kinds of carbon.

Since the oxygen radical is hydrophilic, if the amount of oxygen radicals is small, the hydrophobicity increases, which can be certainly affirmed by the following simple test.

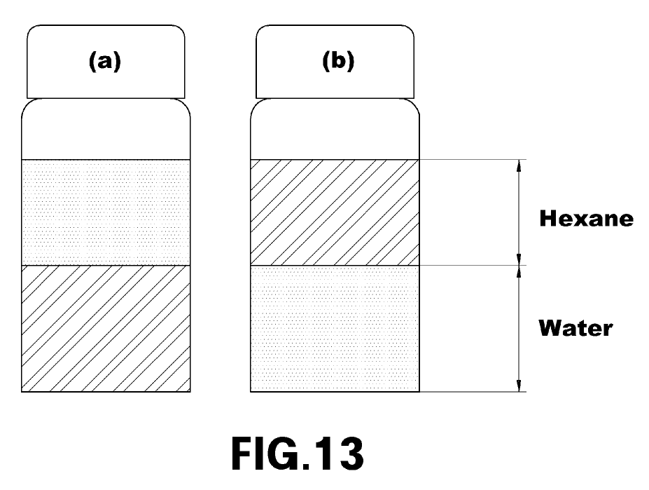

As shown in the photograph of FIG. 13a showing the case where the CNC was put into a beaker containing hexane and water, the CNC was not distributed in water but distributed in hexane, which was caused because the CNC had high hydrophobicity.

On the contrary, as shown in the photograph of FIG. 13b, the CNF or carbon black was distributed in water since it had higher hydrophilicity than the CNC.

Accordingly, since the carbon corrosion is a carbon gasification reaction in which water reacts with carbon to generate carbon dioxide, the hydrophobicity of carbon prevents its reaction with water to reduce the carbon corrosion, from which it could be concluded that the CNC having high surface hydrophobicity is most suitable for the support.

### Test Example 7

### Evaluation of Catalyst Particle Sintering

Sintering of catalyst particles occurs on the surface of the carbon support as well as the carbon corrosion, which is affected by the shape or roughness of the carbon surface.

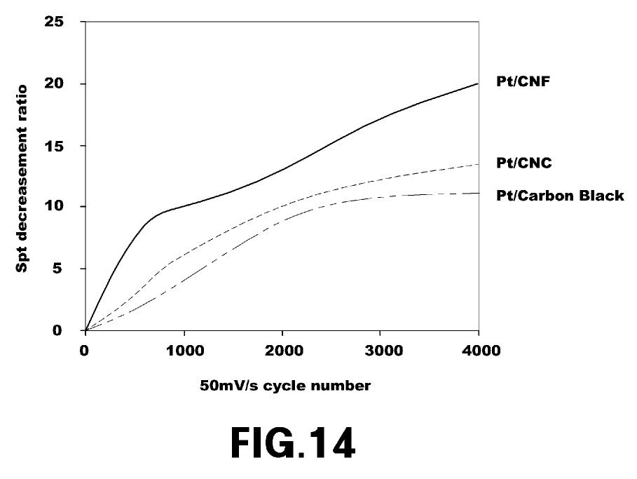

In the case of CNF, the surface roughness is low. Accordingly, the catalyst effective surface area was decreased in the CV test at 0 to 0.8 V and 50 mV/s in H₂SO₄ solution performed in a half cell, and a reduction of 20% was shown after 4,000 cycles as shown in FIG. 14.

However, it could be seen that the catalyst effective surface areas of the Pt/carbon black and Pt/CNC were decreased 13% and 11%, respectively, as shown in FIG. 14.

Accordingly, the CNC according to the present invention has high sintering resistance compared to the CNF or CNT, another kind of crystalline carbon support, which means that the Pt/CNC of the present invention is more suitable for the fuel cell catalyst.

It could be concluded from the above Test Examples that the platinum-supported catalyst using the crystalline carbon nanocages (CNC) had high corrosion resistance and maintained the loading level and platinum particle size corresponding to those of the carbon black. In particular, the fuel cell performance in the case of the carbon nanocages (CNC) was measured higher than the carbon black, from which it could be concluded that the carbon nanocages (CNC) according to the Example of the present invention had high corrosion resistance based on the above-described test method.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A method for manufacturing a catalyst for a fuel cell having excellent corrosion resistance, the method comprising:
a first step of preparing carbon nanocages (CNC) using acetylene black as carbon black;
a second step of mixing predetermined amounts of NaOH, platinum precursor, and carbon with ethylene glycol, which is a solvent but also serves as a reducing agent, and stirring the solution;
a third step of reducing the platinum precursor by oxidizing the ethylene glycol;
a fourth step of increasing loading level of platinum by pH control; and
a fifth step of removing unnecessary organic substances by washing and heat treatment,
wherein the first step comprises:
the step of mixing the acetylene black with a predetermined amount of ferric nitrate [Fe(NO₃)₃9H₂O]; and
the step of heat-treating the resulting solution under a nitrogen atmosphere at 2,400 to 2,800° C. for a predetermined period of time.

2. The method of claim 1, wherein the first step further comprises the step of immersing the carbon nanocages obtained after heat-treatment in nitric acid to remove impurities.

3. The method of claim 1, wherein the second step comprises the step of mixing a predetermined amount of NaOH with the ethylene glycol to maintain pH above 12 and the step of mixing predetermined amounts of platinum precursor and carbon nanocages with the resulting solution and stirring the solution.

4. The method of claim 1, wherein the platinum precursor is one selected from the group consisting of: platinum chloride, potassium tetrachloroplatinate, and tetraammineplatinum chloride.

5. The method of claim 1, wherein the third step comprises the step of refluxing the resulting solution after the first and second steps at 140 to 180° for 3 hours and the step of stirring the resulting solution for 12 hours after lowering the temperature to room temperature after reaction and exposing the solution to air.

6. The method of claim 5, wherein glycolate anion generated by the oxidation of the ethylene glycol serves as a protector that prevents the reduced platinum particles from being sintered to each other.

7. The method of claim 1, wherein the fourth step increases the loading level of platinum by lowering the pH using one selected from the group consisting of hydrochloric acid, sulfuric acid, and nitric acid such that the surface potential of the platinum has a predetermined negative potential value and the surface potential of the carbon is increased to a positive value.

8. The method of claim 1, wherein the fifth step comprises the step of completely washing organic acids and impurities generated during the oxidation of the ethylene glycol with ultrapure water and the step of drying the resulting catalyst in a convection oven at 160° C.

9. A method for manufacturing a catalyst for a fuel cell having excellent corrosion resistance, the method comprising:
a first step of preparing carbon nanocages (CNC);
a second step of mixing predetermined amounts of NaOH, platinum precursor, and carbon with ethylene glycol, which is a solvent but also serves as a reducing agent, and stirring the solution;
a third step of reducing the platinum precursor;
a fourth step of increasing loading level of platinum; and
a fifth step of removing unnecessary organic substances,
wherein the first step comprises:
the step of mixing the acetylene black with a predetermined amount of ferric nitrate [Fe(NO₃)₃9H₂O]; and
the step of heat-treating the resulting solution under a nitrogen atmosphere at 2,400 to 2,800° C. for a predetermined period of time.

10. The method of claim 9, wherein the first step of preparing carbon nanocages (CNC) further comprises using acetylene black as carbon black.

11. The method of claim 9, wherein the third step of reducing the platinum comprises oxidizing the ethylene glycol.

12. The method of claim 9, wherein the fourth step of increasing loading level of platinum is carried out by pH control.

13. The method of claim 9, wherein the fifth step of removing unnecessary organic substances is carried out by washing and heat treatment.

14-15. (canceled)

16. The method of claim 9, wherein the first step further comprises the step of immersing the carbon nanocages obtained after heat-treatment in nitric acid to remove impurities.
